(19) United States
(12) Patent Application Publication
(10) Pub. No.: US 2010/0128130 A1
(43) Pub. Date: May 27, 2010

(54) SYSTEMS AND METHODS TO MONITOR VIDEO QUALITY

(75) Inventor: Jerald Robert Howcroft, Beverly Hills, MI (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/277,137

(22) Filed: Nov. 24, 2008

(51) Int. Cl. H04N 17/00; G06F 3/00; H04N 7/173

(52) U.S. Cl. 348/180; 715/719; 725/93; 348/E17.001

(57) ABSTRACT

Systems, methods and graphical user interfaces monitoring video quality are provided. A particular method includes transmitting a video stream to an end user device of an ITV network for viewing at the end user device. The method also includes selecting the video stream for monitoring by a monitoring application. The method also includes transmitting the video stream to the monitoring application. The method also includes monitoring the video stream.

### I. FIELD

The present disclosure is generally related to monitoring video quality.

### II. DESCRIPTION OF RELATED ART

Interactive Television (ITV) services can suffer from quality issues in the transmission of video to end user devices. Users may inform the provider of the ITV service of quality issues by contacting service provider such as by phone, email or in other manners. However, by the time a user contacts the ITV service provider, the user is likely already a dissatisfied customer.

### III. BRIEF DESCRIPTION OF THE DRAWINGS

FIG. 1 is a diagram of a first particular embodiment of a system to monitor video quality.

FIG. 2 is a diagram of a second particular embodiment to monitor video quality.

FIG. 3 is a diagram of a third particular embodiment to monitor video quality;

FIG. 4 is a flow diagram illustrating a first particular embodiment of a method of monitoring video quality.

FIG. 5 is a flow diagram illustrating a second particular embodiment of a method of monitoring video quality.

FIG. 6 is a illustration of a first particular embodiment of a screen used in a system for monitoring video.

FIG. 7 is a illustration of a second particular embodiment of a screen used in a system for monitoring video quality.

FIG. 8 is a illustration of a third particular embodiment of a screen used in a system for monitoring video quality.

FIG. 9 is a illustration of a fourth particular embodiment of a screen used in a system for monitoring video quality.

FIG. 10 is a diagram of an illustrative computing system.

### IV. DETAILED DESCRIPTION

A particular method for monitoring video quality includes transmitting a video stream to an end user device of an interactive television (ITV) network for display at the end user device. The method also includes selecting the video stream for monitoring by a monitoring application. The method also includes transmitting the video stream to the monitoring application. The method also includes monitoring the video stream.

A second particular method for monitoring video quality of a video stream as displayed at an end user device via an interactive television network includes selecting, for monitoring, one of an available set of interactive television applications displaying a video stream at an end user device. The method also includes selecting a location for monitoring. The method also includes selecting a video stream for monitoring. The method also includes displaying the video stream for monitoring, the video stream being displayed substantially simultaneously with display of the video stream at the end user device.

A particular system includes a video on demand (VOD) server configured to multicast a video stream. The particular system further includes a VOD cache server configured to receive the video stream from the VOD server, to store the video stream, to send the video stream to an end user device and to send the video stream to a video monitoring server. In the particular system, the video monitoring system is configured to receive the video stream.

A particular video stream monitoring server includes an input to receive a video stream from a cache server substantially simultaneously with the video stream being received by an end user device. The particular video stream monitoring server also includes a monitoring device displaying the video stream to monitor events in the transmission of the video stream. The particular video stream monitoring server also includes an output to report when an event occurs.

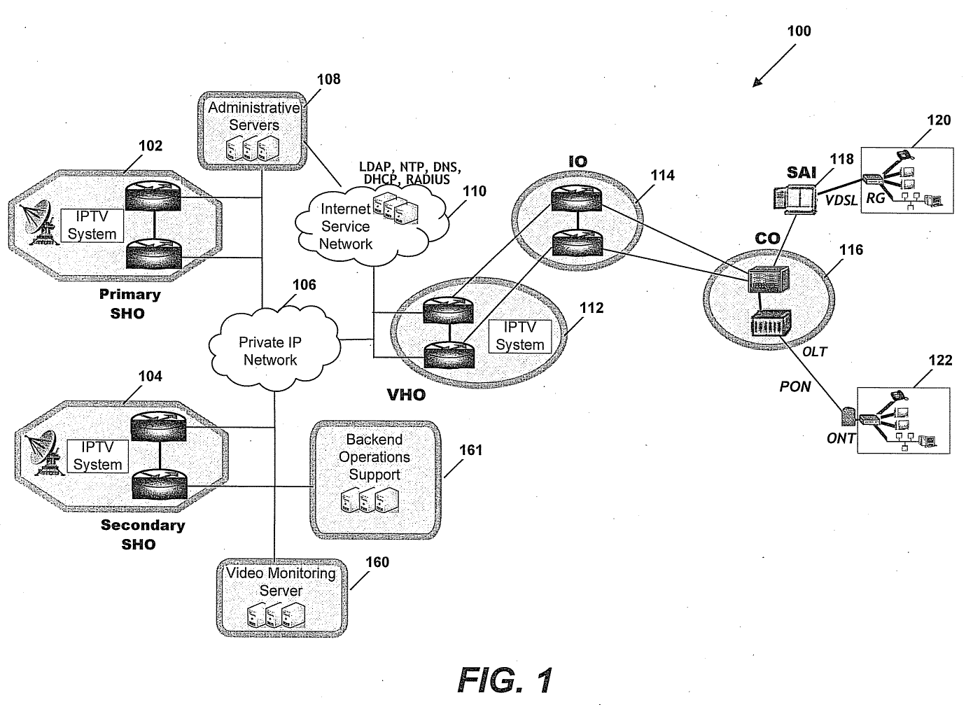

Referring to FIG. 1, a first particular embodiment of a system to monitor video quality is illustrated and designated generally 100. The system 100 includes a primary super head-end office (SHO) 102, also referred to as a super hub office, and a secondary SHO 104 of a service provider network. The primary SHO 102 may include one or more routers, one or more switches, one or more servers, or any combination thereof. In a particular embodiment, a server associated with the primary SHO 102 is adapted to provide IPTV services to one or more subscriber premises. The primary SHO 102 may include a number of software applications related to providing video services to the subscriber premises. In an illustrative embodiment, the primary SHO 102 includes servers, routers, switches, or any combination thereof to provide multicast services to the subscriber premises. Additionally, the primary SHO 102 may include servers, routers, switches, or any combination thereof, to provide unicast services to the subscriber premises. For example, the primary SHO 102 may be adapted to provide high-speed Internet services, Voice over Internet Protocol (VoIP) services, IPTV services, such as Instant Channel Change (ICC) services, or any combination thereof to the subscriber premises. Additionally, the primary SHO 102 may receive or acquire television content, movie content, advertisement content, other video content, or any combination thereof, from a broadcast service, such as a satellite acquisition system.

The primary SHO 102 may communicate with the secondary SHO 104 via a service provider network, such as a private Internet Protocol (IP) network 106. The secondary SHO 104 may include one or more routers, one or more switches, one or more servers, or any combination thereof. In a particular embodiment, a server associated with the secondary SHO 104 is adapted to provide video services to one or more subscriber premises. The secondary SHO 104 may include a number of software applications related to providing video services to subscriber premises. In an illustrative embodiment, the secondary SHO 104 includes servers, routers, switches, or any combination thereof to provide multicast services to the subscriber premises. For example, the secondary SHO 104 may be adapted to provide multicast video services to the one or more subscriber premises. Additionally, the secondary SHO 104 may include servers, routers, switches, or any combination thereof, to provide unicast services to the subscriber premises. For example, the secondary SHO 104 may be adapted to provide high-speed Internet services, Voice over Internet Protocol (VoIP) services, IPTV services, such as Instant Channel Change (ICC) services, or any combination thereof to the subscriber premises. Additionally, the secondary SHO 104 may receive or acquire television content, movie content, advertisement content, other video content, or any combination thereof, from a broadcast service, such as a satellite acquisition system. The secondary SHO 104 may provide services redundant to those of the primary SHO 102, a different set of services than the services provided by the primary SHO 102, or any combination thereof. In addition, the secondary SHO 104 may serve the same subscriber premises that the primary SHO 102 serves, different subscriber premises than the SHO 102, or any combination thereof. Further, both the primary SHO 102 and the secondary SHO 104 may stream video content to the subscriber premises.

In an illustrative, non-limiting embodiment, the secondary SHO 104 serves as a disaster recovery SHO in the case of a failure of the primary SHO 102. To illustrate, if the primary SHO 102 becomes inoperable to provide IPTV services to the subscriber premises, the secondary SHO 104 may be adapted to take over functions previously assigned to the primary SHO 102.

In a particular embodiment, the primary SHO 102 and the secondary SHO 104 may stream video content to a number of subscriber premises related to television shows, movies, live programming, pay-per-view programming, video on-demand programming, or any combination thereof.

In a particular embodiment, the system 100 includes administrative servers 108 and an Internet service network 110. The administrative servers 108 may be adapted to store and process information related to subscriber accounts. For example, the administrative servers 108 may include data related to subscriber billing, subscriber profiles, services authorized for particular subscribers, or any combination thereof. The Internet service network 110 may be adapted to manage Internet Protocol traffic throughout the system 100. For example, the Internet service network 110 may be adapted to manage the assignment of Internet Protocol addresses throughout the system 100. The administrative servers 108 and the Internet service network 110 may communicate with other components of the system 100 via a private IP network 106. In addition, the administrative servers 108 and the Internet service network 110 may communicate via a direct communication link.

In a particular embodiment, the system 100 includes a video head-end office (VHO) 112, also referred to as a video hub office. The video head-end office 112 may include one or more servers, one or more switches, one or more routers, or any combination thereof. In a particular embodiment, a server associated with the VHO 112 is adapted to provide video services to the one or more subscriber premises. The VHO 112 may include a number of software applications related to providing video services to the subscriber premises. In an illustrative embodiment, the VHO 112 includes servers, routers, switches, or any combination thereof to provide multicast services to the subscriber premises. For example, the VHO 112 may be adapted to provide the multicast video services to the one or more subscriber premises. Additionally, the VHO 112 may include servers, routers, switches, or any combination thereof, to provide unicast services to the subscriber premises. For example, the VHO 112 may be adapted to provide high-speed Internet services, Voice over Internet Protocol (VoIP) services, IPTV services, such as Instant Channel Change (ICC) services, or any combination thereof to the subscriber premises.

In a particular embodiment, the system 100 includes an intermediate office (IO) 114. The 10 114 may include one or more servers, one or more switches, one or more routers, or any combination thereof. In an illustrative embodiment, the IO 114 includes servers, routers, switches, or any combination thereof to provide multicast services to the subscriber premises. For example, the IO 114 may be adapted to provide multicast video services to the one or more subscriber premises. Additionally, the IO 114 may include servers, routers, switches, or any combination thereof, to provide unicast services to the subscriber premises. For example, the IO 114 may be adapted to provide high-speed Internet services, Voice over Internet Protocol (VoIP) services, IPTV services, such as Instant Channel Change (ICC) services, or any combination thereof to the subscriber premises.

In a particular embodiment, the system 100 includes a central office (CO) 116. The CO 116 may include one or more servers, one or more switches, one or more routers, or any combination thereof. In an illustrative embodiment, the CO 116 includes servers, routers, switches, or any combination thereof to provide multicast services to the subscriber premises. For example, the CO 116 may be adapted to provide multicast IPTV services to the one or more subscriber premises. Additionally, the CO 116 may include servers, routers, switches, or any combination thereof, to provide unicast services to the subscriber premises. For example, the CO 116 may be adapted to provide high-speed Internet services, Voice over Internet Protocol (VoIP) services, IPTV services, such as Instant Channel Change (ICC) services, or any combination thereof to the subscriber premises.

The CO 116 may communicate with a service area interface (SAI) 118. In an illustrative embodiment, the SAI includes a digital subscriber line access multiplexer (DSLAM) to provide IPTV services to a first subscriber premises 120. The SAI 118 may communicate with one or more set-top box devices of the first subscriber premises 120 via customer premises equipment. In an illustrative, non-limiting embodiment, the customer premises equipment includes a router, a local area network device, a modem (such as a digital subscriber line, also referred to as DSL, modem), a Cable Television system modem, a residential gateway, any other suitable device for facilitating communication between a set-top box device, a personal computer, a VoIP telephone, or any combination thereof, of the subscriber premises 120 and the SAI 118. Further, the SAI 118 may communicate with customer premises equipment of the subscriber premises 120 via a very high data rate subscriber loop (VDSL).

The CO 116 may also communicate with a second subscriber premise 122 via a fiber optic network. For example, the CO 116 may communicate with the second subscriber premises via a passive optical network (PON). The passive optical network may include an optical line terminal (OLT) and an optical network terminal (ONT).

The components of the system 100 may communicate with each other via any number of communications network connections. For example, the components of the system 100 may communicate with each other via a fiber optic network connection, via a gigabit Ethernet connection, such as a 1 gigE connection or a 10 gigE connection, or any combination thereof.

In a particular embodiment, the system 100 includes video monitoring servers 160. A video stream may be transmitted to an end user device such as an end user device at the subscriber premise 120 or the subscriber premise 122 over an interactive television network, such as is illustrated by the system 100. The end user device may include, for example, a set top box device, a television, a computer, another display device, or any combination thereof. The video stream may be selected for monitoring by a monitoring application executing at the video monitoring server 160. The video stream may be sent to the monitoring application, and monitored. In the particular embodiment, the video monitoring server 160 communicates with the interactive television network over a private IP network 106. In another particular embodiment, the video monitoring server 160 may be located elsewhere in the system 100. For example, the video monitoring server 160 may be located at the primary SHO 102, at the secondary SHO 104 or at the VHO 112.

In a particular embodiment, the video monitoring server 160 is adapted to detect the occurrence of an event in the video stream. For example, the event may be detection of an event with respect to the quality of the video stream, detection of an event with respect to the frame rates in the video stream, detection of an event with respect to the bandwidth available for transmission of the video stream, detection of an event with respect to the rate of skipped frames, detection of an event with respect to the rate of lost packets, detection of an event with respect to the bit rate, detection of other issues with the video stream or any combination of the above. For example, the event may be detecting that the frame rate in the video stream falls below a first threshold value, detecting that the available bandwidth falls below a second threshold value, detecting that the rate of skipped frames exceeds a third threshold value, detecting that the rate of lost packets exceeds a fourth threshold value or detecting the bit rate falls below a fifth threshold value or any combination thereof. The first threshold value, the second threshold value, the third threshold value, the fourth threshold value and the fifth threshold value may be set to values deemed appropriate by the user.

The occurrence of the event may be reported, for example, to a backend operations support module 161, or other server. In a particular embodiment, the backend operations support module 161 communicates with the interactive television network over the private IP network 106. In other embodiments, the backend operations support module 161 is located elsewhere in the system 100. For example, the backend operation support module 161 may be located at the primary SHO 102, at the secondary SHO 104 or at the VHO 112.

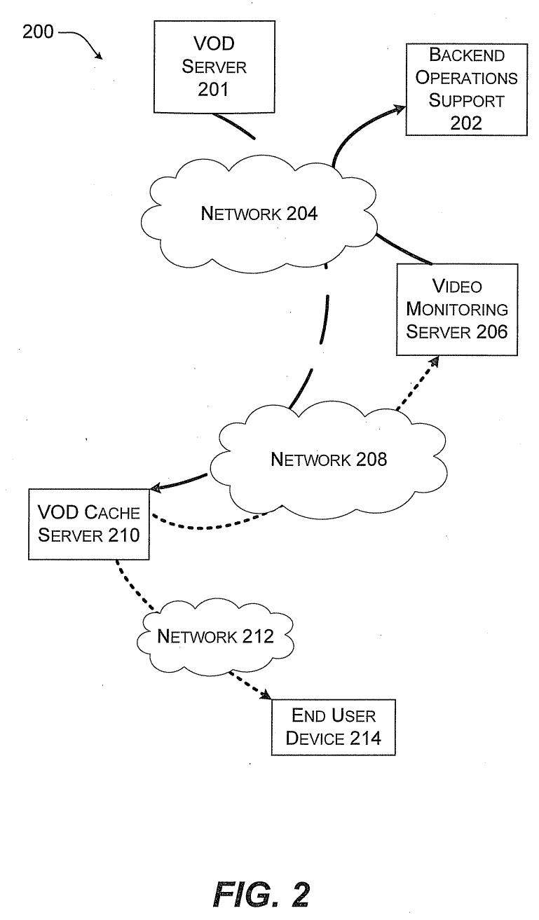

Referring to FIG. 2, a second particular embodiment of a system to monitor video quality is illustrated and designated generally 200. The network includes a video-on-demand (VOD) server 201 configured to multicast a video stream. In the particular embodiment, the VOD server 201 multicasts the video stream over a network 204 and a network 208 to a VOD cache server 210. The network 204 may be a first private IP network and the network 208 may be a second private IP network. In another embodiment, a single private IP network may be utilized. In a particular embodiment, the video stream is transmitted by the VOD server 201 to the VOD cache server 210 in a packet format. In another particular embodiment, the video stream is transmitted by the VOD server 201 to the VOD cache server 210 in an internet protocol (IP) format.

The VOD cache server 210 may be configured to receive the video stream from the VOD server 201 and to transmit the video stream to an end user device 214 which may be located at a subscriber premises. The end user device 214 may be, for example, a television, a computer or other display device. The VOD cache server 210 may further be configured to transmit the video stream to a video monitoring server 206. In a particular embodiment, the VOD cache server 210 is configured to transmit the video stream to the video stream monitoring server 206 substantially simultaneously with the video stream being transmitted to an end user device. As a result, absent delays in transmission of the video stream over the network 212 that differ from delays in the transmission of the vide stream over the network 208, the video stream is received substantially simultaneously at the video stream monitoring server 206 and at the end user device. In another particular embodiment, the video monitoring server 206 is configured to execute a monitoring application and the monitoring application displays the video stream at a display, for example, located at the video monitoring server 206.

In a particular embodiment, the video monitoring server 206 is configured to provide for detection of an event in the video stream. For example, the event may be detection of an event with respect to the quality of the video stream, detection of an event with respect to the frame rates in the video stream, detection of an event with respect to the bandwidth available for transmission of the video stream, detection of an event with respect to the rate of skipped frames, detection of an event with respect to the rate of lost packets, detection of an event with respect to the bit rate, detection of other issues with the video stream or any combination of the above. In a particular embodiment, the video monitoring server 206 is configured to report the event to a backend operations support module 202. The backend operations support module 202 may be configured to receive notification of events.

In a particular embodiment, the video stream monitoring server 206 is located at a super hub office (SHO). In another particular embodiment, the backend operations support module 202 is located at the SHO. In another particular embodiment, the VOD cache server 210 is located at a video hub office (VHO).

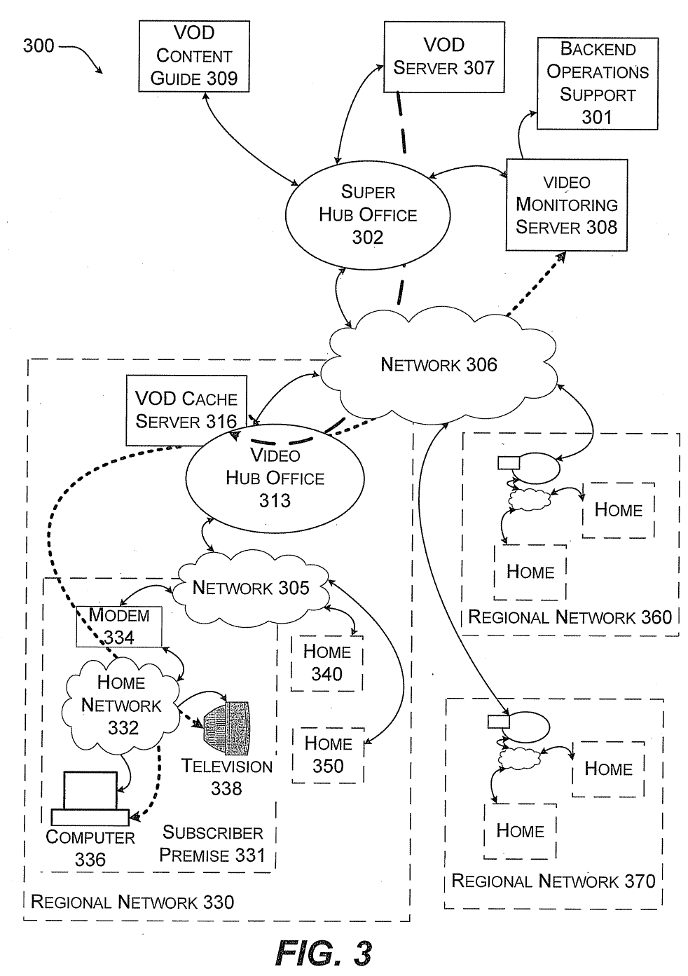

Referring to FIG. 3, a third particular embodiment of a system to monitor video quality is illustrated and designated generally 300. The system 300 includes a super hub office (SHO) 302 configured to communicate over a network 306 to a video hub office (VHO) 313. The network 306 may be a private internet protocol (IP) network. The VHO 313 is configured to provide video services to subscriber premises (e.g., homes) 331, 340, 350 in a regional network 330. For example, the VHO 313 may communicate over a network 305 to a first subscriber premise 331. (The first subscriber premise 331 may have a modem 334 configured to receive content, including video content from a VOD cache server 316 and to communicate requests and content via the network 305. The modem 334 may communicate, via a home network 332, video and other content with an end user device such as the computer 336, a television 338 or another end user device and other display devices.)

Other subscriber premises, such as home 340 and home 350, may be similarly configured. Other VHOs and VOD cache servers may be configured to communicate over the network 306 to other regional networks such as a regional network 360 and a regional network 370.

The network 300 may include a VOD server 307 configured to transmit a video stream. In a particular embodiment, the VOD server 307 multicasts the video stream. The video stream may be transmitted over the network 306 to the VOD cache server 316.

The VOD cache server 316 may be configured to receive the video stream from the VOD server 307, to store the video stream, and to transmit the video stream to an end user device, such as for example, the television 338 or the computer 336. The VOD cache server 316 may be configured to unicast the video stream to the end user device. The VOD cache server 316 may also be configured to transmit the video stream to a video monitoring server 308. The VOD cache server 316 may be configured to unicast the video stream to the video monitoring server 308. The video stream may be transmitted from the VOD cache server 316 to the video monitoring server 308 over the network 306. The video monitoring server 308 may be configured to receive the video stream. In a particular embodiment, the video monitoring server 308 is configured to provide for detection of an event in the video stream. For example, the event may be detection of an event with respect to the quality of the video stream, detection of an event with respect to the frame rates in the video stream, detection of an event with respect to the bandwidth available for transmission of the video stream, detection of an event with respect to the rate of skipped frames, detection of an event with respect to the rate of lost packets, detection of an event with respect to the bit rate, detection of other issues with the video stream or any combination of the above.

In another particular embodiment, the video monitoring server 308 is configured to report the event to a backend operations support module 301. The backend operations support module 301 may be configured to receive notification of events. The backend operations support module 301 may be configured to troubleshoot the events, provide an alarm that an event has occurred, or take other action with respect to the event.

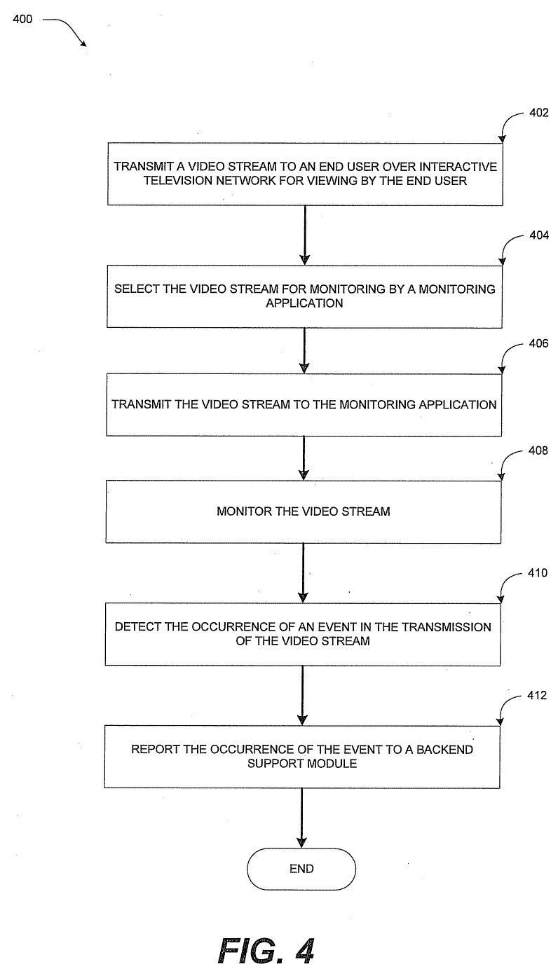

Referring to FIG. 4, a flow diagram illustrates a first particular embodiment of a method of monitoring video quality and is designated generally as 400. The method includes transmitting a video stream to an end user device over an interactive television network for viewing at an end user device at 402. The method further includes selecting a video stream for monitoring by a monitoring application at 404. In a particular embodiment, the monitoring application executes at a video monitoring server such as the video monitoring server 308 of FIG. 3. The method may further include transmitting the video stream to the monitoring application at 406 and monitoring the video stream at 408. In a particular embodiment, the video stream is monitored by a person watching the video stream at a display. In other particular embodiments, the video stream is monitored by the monitoring application monitoring various aspects of the video stream, for example, as the video stream is received.

The method may further include detecting the occurrence of an event in the transmission of the video stream at 410. For example, the event may be detection of an event with respect to the quality of the video stream, detection of an event with respect to the frame rates in the video stream, detection of an event with respect to the bandwidth available for transmission of the video stream, detection of an event with respect to the rate of skipped frames, detection of an event with respect to the rate of lost packets, detection of an event with respect to the bit rate, detection of other issues with the video stream or any combination of the above.

The method may further include reporting the occurrence of the event to a backend operations support module at 412. In one particular embodiment, the backend operations support module is the backend operations support module 301 of FIG. 3.

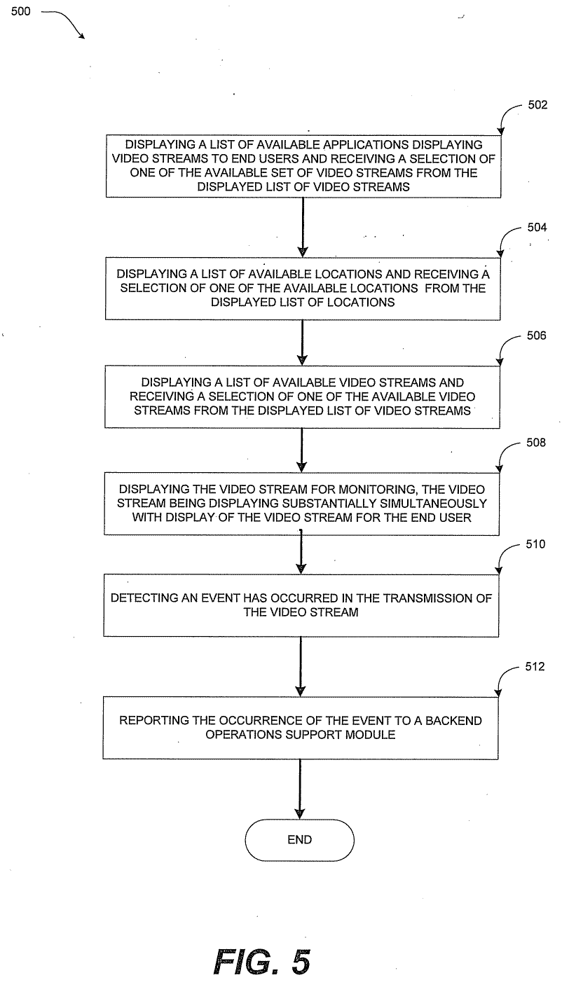

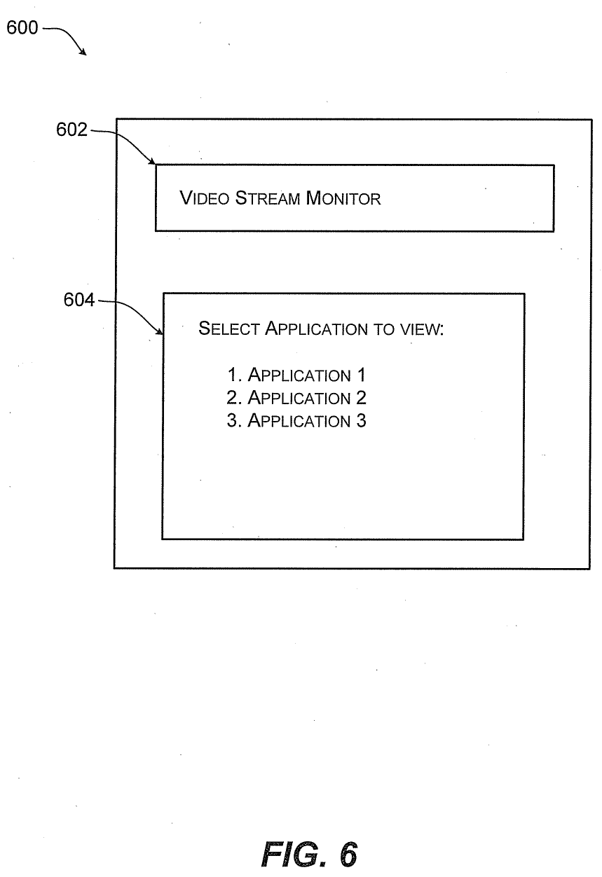

Referring to FIG. 5, a flow diagram illustrates a second particular embodiment of a method of monitoring video quality and is designated generally as 500. The method may include displaying a list of available applications displaying video streams to end user devices and receiving a selection of one of the available applications displaying video streams from the displayed list, at 502. In a particular embodiment, the list of available applications displaying video streams to end user devices are displayed. A particular embodiment of a display including a list of available applications is illustrated in FIG. 6 as screen 600. The screen 600 includes a caption 602 and a list of available applications 604. For example, the applications may be an application for viewing weather related information, an application for shopping, an application to view local video programming (e.g., such as local high school athletic events and local governmental meetings), other applications, or any combination thereof. In particular embodiments, the screen 600 displays other information of use to the viewer. The screen 600 may enable a user to select one the available set of applications for monitoring such as by using a cursor control device to navigate to the application to be selected. In other embodiments, a touch screen or other alternate technology is utilized to enable the user to select one of the available set of applications.

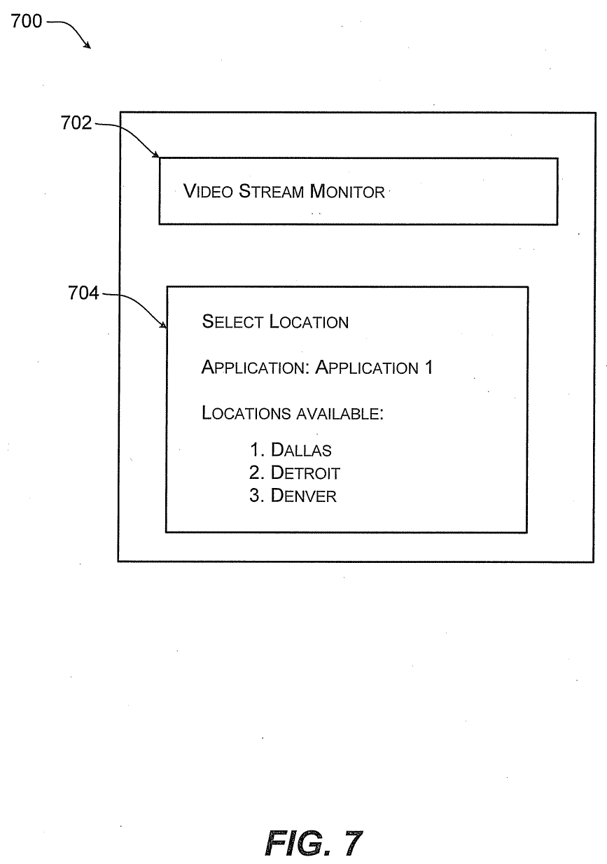

Returning to FIG. 5, the method may further include displaying a list of available locations and receiving a selection of one of the available locations from the displayed list of locations, at 504. In a particular embodiment, the list of available locations is displayed. A particular embodiment of a display including a list of available locations is illustrated in FIG. 7 as screen 700. The screen 700 includes a caption 702 and a list of available locations 704. In particular embodiments, the screen 700 may display other information of use to the viewer. The screen 700 may enable a user to select one of the available set of locations for monitoring such as by using a cursor control device, touch screen or alternate technology to select the location for monitoring.

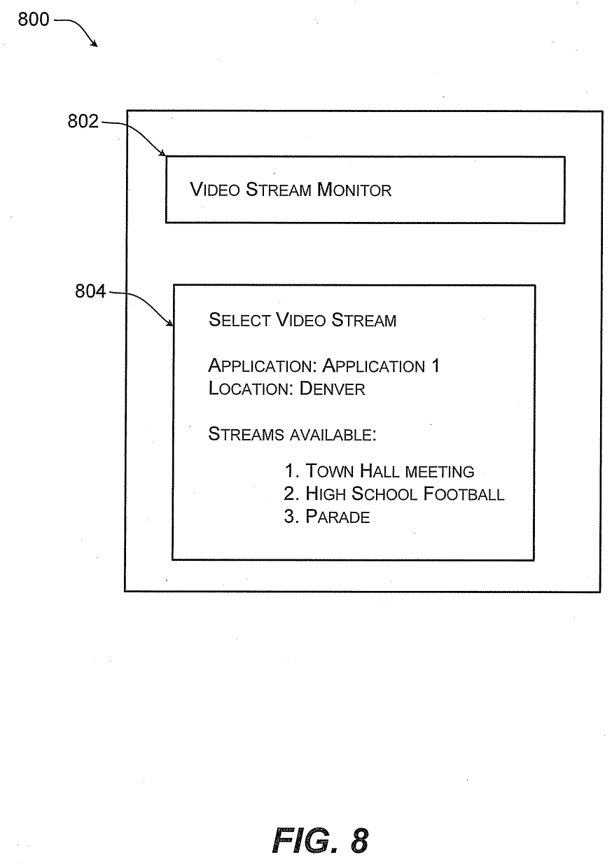

Returning to FIG. 5, the method may further include displaying a list of available video streams and receiving a selection of one of the available video streams from the displayed list of video streams, at 506. In a particular embodiment, the list of available video streams is displayed at a display. A particular embodiment of a display including a list of available video streams is illustrated by FIG. 8 as screen 800. The screen 800 includes a caption 802 and a list of available video streams 804. In particular embodiments, the screen 800 displays other information of use to the viewer. The screen 800 may enable a user to select one of the available video streams for monitoring such as by using a cursor control device, touch screen or alternate technology to select the location for monitoring.

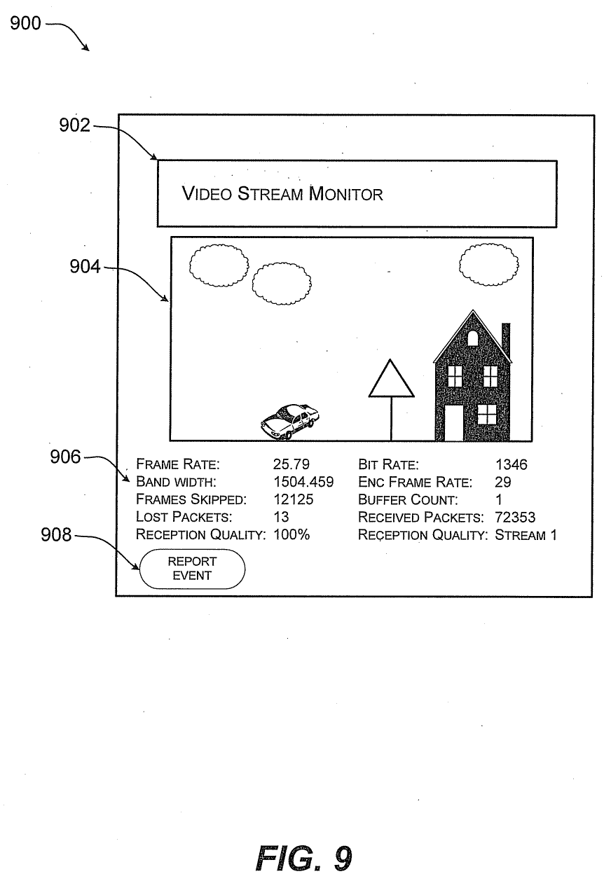

Returning to FIG. 5, the method may further include displaying the video stream for monitoring, at 508. The video stream may be displayed for monitoring substantially simultaneously with display of the video stream at an end user device. In a particular embodiment, the video stream is displayed at a display. A particular embodiment of a display displaying the video stream is illustrated by FIG. 9 as screen 900. The screen 900 includes a caption area 902, section 904 displaying the video stream and a section 906 displaying various attributes of the video stream such as a frame rate, bandwidth, frames skipped, lost packets, reception quality, bit rate, buffer count, received packets and reception quality. In particular embodiments, the screen 900 displays other information of use to the viewer.

Returning to FIG. 5, the method may further include detecting the occurrence of an event in the transmission of the video stream, at 510. In a particular embodiment, the event is detected by the viewer based on observing the video stream such as by observing the screen 900 illustrated in FIG. 9. For example, the event may be detected by the viewer observing the video stream displayed in section 904, or by observing the various attributes displayed in section 906. In still other particular embodiments, the event is detected automatically by a system detecting that certain attributes fall outside of acceptable ranges.

Returning to FIG. 5, the method may further include reporting the occurrence of the event to a backend operations support module, at 512. In a particular embodiment, the screen 900 includes a button, link, field or other area 908 enabling a user to report an event when an event occurs in the transmission of a video stream. The reporting may include, for example, information identifying the application being monitored, the location being monitored, the video stream being monitored, the attributes of the video stream being monitored and the time and day the video stream was being monitored. In another particular embodiment, the reporting of the occurrence of the event is carried out automatically by a system monitoring the video stream. In a particular embodiment, the occurrence of the event is reported to a backend operations support module, such as backend operations support module 161 of FIG. 1, backend operations support module 202 of FIG. 2, or backend operations support module 301 of FIG. 3.

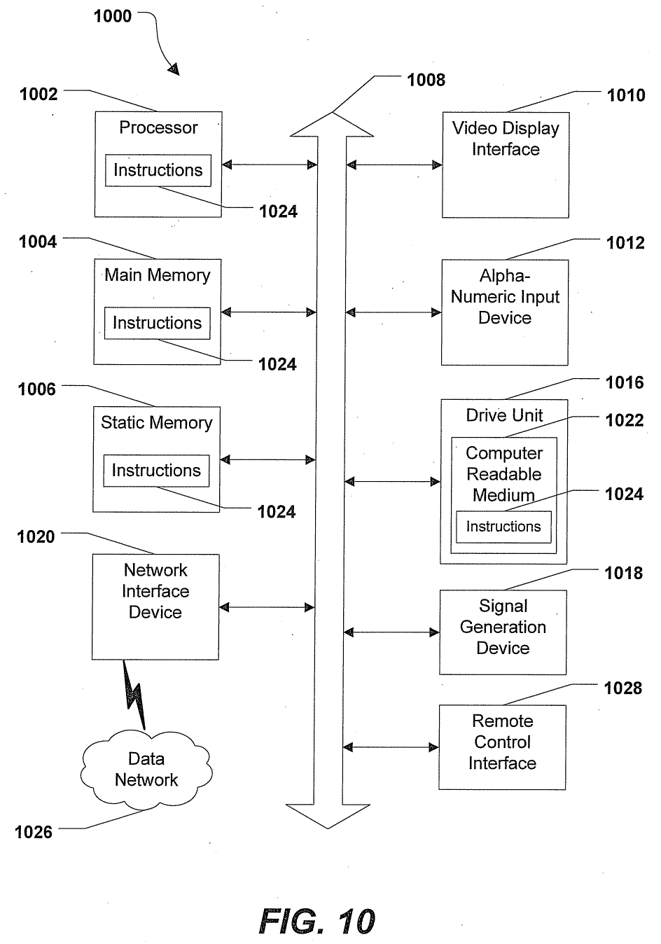

Referring to FIG. 10, an illustrative embodiment of a general computer system is shown and is designated 1000. The computer system 1000 can include a set of instructions that can be executed to cause the computer system 1000 to perform any one or more of the methods or computer based functions disclosed herein. The computer system 1000 may operate as a standalone device or may be connected, e.g., using a network, to other computer systems or peripheral devices. For example, the computer system 900 may include or be included within any one or more of the primary SHO 102, the secondary SHO 104, the administrative servers 108, the video monitoring server 160, the backend operations support module 161, the VHO 112, the IO 114, and the CO 116, the backend operations support module 202, the VOD stream monitoring server 206, the VOD cache server 210, the VOD content guide 309, the VOD server 307, the backend support module 301, the VOD stream monitoring server 308, the SHO 302, the VOD cache server 306, the VHO 313, the computer 336, the home network 332 and the modem 334 as discussed with reference to FIGS. 1-3.

In a networked deployment, the computer system may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. Moreover, the computer system 1000 can include a main memory 1004 and a static memory 1006, that can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. The computer system 1000 can also include a disk drive unit 1016, a signal generation device 1018, such as a speaker or remote control, and a network interface device 1020.

In a particular embodiment, as depicted in FIG. 10, the disk drive unit 1016 includes a computer-readable medium 1022 in which one or more sets of instructions 1024, e.g. software, can be embedded. Further, the instructions 1024 may embody one or more of the methods or logic as described herein. In a particular embodiment, the instructions 1024 reside completely, or at least partially, within the main memory 1004, the static memory 1006, and/or within the processor 1002 during execution by the computer system 1000. The main memory 1004 and the processor 1002 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory.

Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable storage medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols.

For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
transmitting a video stream to an end user device over an interactive television network for display at the end user device;
selecting the video stream for monitoring by a monitoring application;
transmitting the video stream to the monitoring application; and
monitoring the video stream.

2. The method of claim 1, further comprising:
detecting an occurrence of an event in the transmission of the video stream to the monitoring application; and
reporting the occurrence of the event.

3. The method of claim 2, wherein the event is detection of an event with respect to the video quality of the video stream.

4. The method of claim 2, wherein the event is detection of an event with respect to the frame rates in the video stream.

5. The method of claim 2, wherein the event is detection of an event with respect to the bandwidth available for transmission of the video stream.

6. The method of claim 2, wherein the event is detection of an event with respect to the rate of skipped frames in the video stream.

7. The method of claim 2, wherein the event is detection of an event with respect to the rate of lost packets in the video stream.

8. The method of claim 2, wherein the event is detection of an event with respect to the reception quality in the video stream.

9. The method of claim 2, wherein the event is detection of an event with respect to the bit rate in transmission of the video stream.

10. The method of claim 2, wherein the occurrence of the event is reported to a backend operations support module.

11. The method of claim 1, wherein the video stream is displayed at a display device by the monitoring application.

12. The method of claim 1, wherein selecting the video stream for monitoring by the monitoring application comprises:
selecting an interactive television application associated with one or more video streams to be monitored;
selecting a location to be monitored; and
selecting the video stream from the one or more video streams.

13. A method for monitoring video quality, as displayed at an end user device, via an interactive television network comprising:
selecting, for monitoring, one of an available set of interactive television applications displaying a video stream at an end user device;
selecting a location for monitoring;
selecting a video stream for monitoring; and
displaying the video stream for monitoring, the video stream being displayed substantially simultaneously with display of the video stream at the end user device.

14. The method of claim 13, further comprising:
detecting an occurrence of an event associated with transmission of the selected video stream; and
reporting the occurrence of the event to a backend operation support module.

15. The method of claim 13, further comprising displaying a list of available sets of interactive television applications for monitoring, and receiving a selection of one of the available sets of interactive television applications from the displayed list of available interactive television applications.

16. The method of claim 13, wherein the video stream is formatted for transmission from a video on demand (VOD) cache server to a monitoring server in a packet format.

17. The method of claim 13, wherein the video stream is formatted for transmission from a video on demand (VOD) cache server to a monitoring server in an internet protocol (IP) format.

18. The method of claim 20, wherein the video stream is formatted for transmission from the VOD cache server to an end user device in an internet protocol (IP) format.

19. A system, comprising:
a video on demand (VOD) server configured to multicast a video stream;
a VOD cache server configured to receive the video stream from the VOD server, to store the video stream, to send the video stream to an end user device and to send the video stream to a video monitoring server; and
the video monitoring server configured to receive the video stream.

20. The system of claim 19, wherein the video monitoring server is further configured to detect an event in the video stream.

21. The system of claim 20, wherein the video monitoring server is further configured to report the event to a backend operations support module, the backend operations support module configured to receive notification of events.

22. The system of claim 19, wherein the video monitoring server is located at a super hub office (SHO).

23. The system of claim 19, wherein the VOD cache server is located at a video hub office (VHO).

24. A video stream monitoring server comprising:
an input to receive a video stream from a cache server substantially simultaneously with the video stream being received by an end user device;
a monitoring device displaying the video stream to monitor events in transmission of the video stream; and
an output to report when an event occurs.

25. The video stream monitoring server of claim 24, wherein the video stream monitoring server is configured to report the event over the output to a backend operations support module, the backend operations support module configured to receive notification of events.
